(19) United States
(12) Patent Application Publication
(10) Pub. No.: US 2008/0139687 A1
(43) Pub. Date: Jun. 12, 2008

(54) Vinyl Ether/Acrylate Block Resins, Compositions and Methods of Making Same

(75) Inventors: John G. Woods, Farmington, CT (US); Joel D. Schall, Hamden, CT (US); Steven T. Nakos, Andover, CT (US); Anthony F. Jacobine, Meriden, CT (US)

Correspondence Address: LOCTITE CORPORATION, 1001 TROUT BROOK CROSSING, ROCKY HILL, CT, 06067, US

(73) Assignee: Henkel Corporation, Rocky Hill, CT (US)

(21) Appl. No.: 11/814,584

(22) PCT Filed: Nov. 10, 2005
(86) PCT No.: PCT/US05/40856

§ 371 Date: Jul. 24, 2007

(51) Int. Cl. C08G 18/63

(52) U.S. Cl. 522/31; 525/455; 525/450; 522/96; 522/47; 522/63; 522/37

(57) ABSTRACT

The present invention relates to vinyl ether or acrylate terminated block resins, compositions incorporating same and methods for preparing same. In particular, the compositions of the present invention may contain a vinyl ether or acrylate terminated block resin, such as a polyurethane block copolymer, a reactive diluent having vinyl ether or 1-alkenyl ether and (meth)acrylate functionality and a curing initiator. The compositions may be exposed to an energy source, e.g., photoradiation, to impart tack-free surface cure.

### BACKGROUND OF THE INVENTION

1. Field of the Invention

The present invention relates to vinyl ether or acrylate terminated block resins, compositions incorporating same and methods for preparing same. The compositions may include a reactive diluent that has vinyl ether or 1-alkenyl ether and (meth)acrylate functionality. The compositions may be exposed to an energy source, e.g., photoradiation, to impart tack-free surface cure.

2. Brief Description of Related Technology

A variety of polyurethane resins have been developed that may be used as adhesives, sealants, coatings, and the like. Among such resins are various (meth)acrylate terminated polyurethane block copolymers, which have alternating hard and soft segments in the polymer backbone. Such resins provide good impact and cute-through-volume properties, as described in more detail in U.S. Pat. Nos. 4,018,851, 4,295,909 and 4,309,526 to Baccei, the contents all of which are incorporated by reference herein in their entirety.

Also known are vinyl ether terminated urethane resins, which are not block copolymers. Such vinyl ether terminated resins may be prepared, for example, by reacting the product obtained by addition of acetylene to an organic polyol with an isocyanate. These resins may be used as coatings and the like, as described in U.S. Pat. Nos. Re 33,211, 4,751,273, 4,775,732, 5,019,636 and 5,139,872 to Lapin et al., the contents all of which are incorporated by reference herein in their entirety.

Vinyl ether terminated polyurethane block copolymers, however, were not known prior to the present invention. Additionally, these inventive block copolymers may be incorporated into compositions containing a hybrid reactive diluent, which has both vinyl ether and (meth)acrylate functionality on the same molecule. These inventive copolymers and compositions provide improved properties, including tack-free surface cure upon irradiation, for example by visible light, and good adhesion to polycarbonates.

### SUMMARY OF THE INVENTION

The present invention provides a new class of vinyl ether terminated polyurethane block copolymers. The present invention also provides a class of vinyl ether or acrylate terminated resin compositions containing a hybrid reactive diluent, which has both vinyl ether and acrylate functionality on the same molecule. The compositions of the present invention possess the advantage of tack-free surface cure and good adhesion.

In one aspect of the present invention, there is provided a polyurethane block copolymer including: at least one hard segment and at least one soft segment; and at least two ends, the first end being terminated with a first vinyl ether group and the second end being terminated with a second vinyl ether group.

In another aspect of the present invention, there is provided a polyurethane block copolymer including the structure:

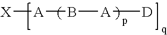

where A is a hard segment; B is a divalent soft segment; X is a q-valent soft segment; D is a vinyl ether group; p is 0-10; and q is 2-6.

In another aspect of the present invention, there is provided a composition including: (a) a polyurethane block copolymer including the structure:

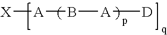

where A is a hard segment; B is a divalent soft segment; X is a q-valent soft segment; D) is a vinyl ether group; p is 0-10; and q is 2-6; (b) a reactive diluent having at least one vinyl ether or 1-alkenyl ether group and at least one (meth)acrylate group; and (c) at least one curing initiator.

In yet another aspect of the present invention, there is provided A composition comprising the reaction product of: (a) a polyurethane block copolymer including the structure:

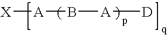

where A is a hard segment; B is a divalent soft segment; X is a q-valent soft segment; D is a vinyl ether group; p is 0-10; and q is 2-6; (b) a reactive diluent including at least one vinyl ether or 1-alkenyl ether group and at least one (meth)acrylate group; and (c) at least one curing initiator.

In another aspect of the present invention, there is provided a composition including: (a) a polyurethane block copolymer including the structure:

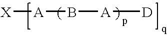

where A is a hard segment; B is a divalent soft segment; X is a q-valent soft segment; D is a (meth)acrylate group; p is 0-10; and q is 2-6; (b) a reactive diluent including at least one vinyl ether or 1-alkenyl ether group and at least one (meth)acrylate group; and (c) at least one curing initiator.

In still another aspect of the present invention, there is provided a composition including the reaction product of: (a) a polyurethane block copolymer including the structure:

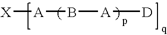

where A is a hard segment, B is a divalent soft segment; X is a q-valent soft segment; D is a (meth)acrylate group; p is 0-10; and q is 2-6; (b) a reactive diluent including at least one vinyl ether or 1-alkenyl ether group and at least one (meth)acrylate group; and (c) at least one curing initiator.

In another aspect of the present invention, there is provided a process for preparing a composition including the steps of: (a) providing a polyurethane block copolymer including the structure:

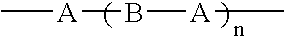

where A is a hard segment; B is a soft segment; and n is 1-10; (b) reacting the block copolymer with a vinyl ether compound to form a vinyl ether terminated block copolymer; and (c) combining the vinyl ether terminated block copolymer with a reactive diluent having at least one vinyl ether or 1-alkenyl ether group and at least one (meth)acrylate group.

In yet another aspect of the present invention, there is provided a process for preparing a composition including the steps of: (a) providing a polyurethane block copolymer including at least one hard segment and at least one soft segment, the block copolymer terminated with (meth)acrylate groups; and (b) combining the (meth)acrylate terminated block copolymer with a reactive diluent having at least one vinyl ether or 1-alkenyl ether group and at least one (meth)acrylate group.

In still another aspect of the present invention, there is provided a method for using the compositions of the present invention to seal together two substrates, including the steps of: (a) applying the composition to at least one of two substrate surfaces, (b) mating the substrate surfaces in abutting relationship to form an assembly; (c) exposing the composition to an energy source selected from radiation, heat and combinations thereof; and (d) maintaining the abutting relationship for a time sufficient to allow the composition to cure.

In yet another aspect of the present invention, there is provided a composition including: (a) a (meth)acrylate; (b) a reactive diluent having at least one vinyl ether or 1-alkenyl ether group and at least one (meth)acrylate group; and (c) at least one curing initiator.

### DETAILED DESCRIPTION OF THE INVENTION

The present invention is directed to a new class of vinyl ether terminated polyurethane block copolymers. The backbone of the block copolymers contains alternating hard and soft segments, which provides sufficient rigidity to function as well as flexibility for impact and movement. The present invention also is directed to vinyl ether or acrylate terminated resin compositions containing a hybrid reactive diluent, which has both vinyl ether and acrylate functionality. The compositions provide tack-free surface cure and good adhesion upon exposure to an energy source, such as photoradiation, and therefore may be useful as adhesives, sealants, coatings, and the like. Additional stability may be provided to the compositions by adding optional components, such as thiols.

The term “cure” or “curing,” as used herein, refers to a change in state, condition, and/or structure in a material that is usually, but not necessarily, induced by at least one variable, such as time, temperature, moisture, radiation, presence and quantity in such material of a curing catalyst or accelerator, or the like. The terms cover partial as well as complete curing.

Some embodiments of the present invention are directed to polyurethane block copolymers having a backbone of alternating hard and soft segments and at least two ends. The ends are each terminated with a vinyl ether group.

In some embodiments of the present invention, this polyurethane block copolymer may be represented by the following general formula (I):

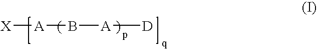

where A is a hard segment:

B is a divalent soft segment;

X is a q-valent soft segment;

D is a vinyl ether group;

p is 0-10; and

q is 2-6.

The polyurethane block copolymer represented by formula (I) has a backbone of alternating hard and soft segments. This may be achieved by the chemical linking of two precursors “prepolymers” which may be subsequently capped with vinyl ether groups. Alternatively, in some embodiments the backbone may be capped with (meth)acrylate groups. A soft, or “flexible,” polyether, polyester or polybutadiene polyol segment may be reacted with a hard, or “rigid,” polyisocyanate, thereby forming urethane linkages. Before reacting with the polyether, polyester or polybutadiene polyol, the polyisocyanate may be reacted with another moiety containing at least two active hydrogen atoms, such as in hydroxy groups, thereby capping the other moiety with —NCO groups.

Accordingly, by the term “hard,” or “rigid,” segment is meant a segment that may contain at least one aromatic, heterocyclic or cycloaliphatic ring, including, for example, bi- and tri-cyclic ring structures. If multiple segments are involved, they may be joined by fusing of the rings or by a minimum number of carbon atoms (e.g.; 1-2 if linear, 1 to about 8 if branched) or hetero atoms such that there is little or no flexing of the segments.

By the term “soft,” or “flexible,” segment is meant a segment that may contain primarily linear aliphatic moieties. The linear aliphatic moieties may include an aliphatic ether or ester or a linear aliphatic moiety containing internal unsaturation, such as hydrocarbon elastomers derived from polybutadienes. Pendant functional groups, including aromatic, heterocyclic and cycloaliphatic, among others, may be present in the soft segment, provided that there is no substantial interference with the desired flexible nature of the segment nor degradation of the cured resin properties disclosed herein.

These hard and soft segments are illustrated by way of example in U.S. Pat. Nos. 4,018,851, 4,295,909 and 4,309,526, referred to above.

The polyurethane block copolymers represented by formula (I) encompass block copolymers having two endgroups, i.e., when q is 2 and thereby X is divalent. Formula (I) also encompasses branching in the copolymer backbone. Branching in the backbone may provide copolymers having up to six endgroups, i.e., q is 6 and thereby X is hexa-valent.

In some embodiments, as described above, X is divalent and, thereby, the polyurethane block copolymer of formula (I) has two vinyl ether endgroups. In such embodiments, the polyurethane block copolymer may be represented as:

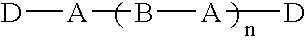

where n is 1-10 and A, B and D are as defined above.

As represented by formula (II) above, the copolymer backbone includes repeating alternating hard (A) and soft (B) segments, desirably up to about n=10. The hard and soft segments are joined through urethane linkages.

In formulas (I) and (II) above, A represents the hard segment. A may be the reaction product of a polyisocyanate and an aromatic, heterocyclic or cycloaliphatic polyol. Accordingly, A may be an aromatic, heterocyclic or cycloaliphatic segment derived from a polyisocyanate.

Examples of suitable polyisocyanates include, but are not limited to: 2,4-tolylene diisocyanate, isophorone diisocyanate, phenyl diisocyanate, 4,4′-diphenyl diisocyanate, 4,4′-diphenylenemethane diisocyanate, dianisidine diisocyanate, 1,5-naphthalene diisocyanate, 4,4′-diphenyl ether diisocyanate, p-phenylene diisocyanate, 4,4′-dicyclohexylmethane diisocyanate, 1,3-bis-(isocyanatomethlyl)cyclohlexane, cyclohexylene diisocyanate, tetrachlorophenylene diisocyanate, 2,6-diethyl-p-phenylenediisocyanate, and 3,5-diethyl-4,4′-diisocyanatodiphenylmethane.

Examples of suitable aromatic, heterocyclic or cycloaliphatic polyols include, but are not limited to: 2,2-(4,4′-dihydroxydiphenyl)-propane, 4,4′-iso-propylidenedicyclohexanol, ethoxylated bisphenol-A, propoxylated bisphenol-A, 2,2-(4,4′-dihydroxydiphenyl)-butane, 3,3-(4,4′-dihydroxydiphenyl)-pentane, α,α′-(4,4′-dihydroxydiphenyl)-p-diisopropylbenzene, 1,3-cyclohexane diol, 1,4-cyclohexane diol, 1,4-cyclohexanedimethanol, bicyclic and tricyclic diols, 2,2,4,4-tetramethyl-1,3-cyclobutanediol, hydroquinone, resorcinol, 2,2-(4,4′-dihydroxyphenyl)-sulfone, and 4,4′-oxydiphenol. A particularly desirable polyol is 4,8-bis(2-hydroxymethyl)tricyclo[5.2.1.0^{2,6}]decane (“HMTD”).

In formulas (I) and (II) above, B and X represent the soft segment. B and X each may be a divalent and multivalent group, respectively, derived from a polyether polyol, polyester polyol or hydrogenated hydrocarbon elastomer, such as polybutadiene.

In some embodiments, the soft segment may be derived from a polyether polyol represented as:

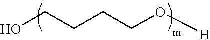

where m is 1-70.

Examples of suitable polyether polyols include, but are not limited to: poly(tetramethylene ether) diol, poly(ethylene)ether glycol, poly(1,2-propylene)ether polyol, poly(1,2- or 1,3-butylene)ether glycol, propoxylated trimethylol propane and ethoxylated glycerol.

Examples of suitable polyester polyols include, but are not limited to: poly(caprolactone), poly(1,6-hexandiol adipate), poly(1,6-hexanediol isophthalate), poly(1,4-butanediol adipate), poly(1,4-butanediol isophthalate), poly(diethylene glycol adipate), poly(diethylene glycol adipate isophthalate), poly(ethylene glycol adipate), poly(ethylene glycol propylene glycol adipate), poly(cyclohexanedimethanol adipate), poly(cyclohexanedimethanol adipate isophthalate), poly(ethylene glycol butylene glycol adipate), poly(1,6-hexanediol neopentyl adipate) and poly(1,6-hexanediol neopentyl isophthalate). Any other combinations of alcohols and acids also may be included.

As represented in formulas (I) and (II), the polyurethane block copolymer may be terminated with vinyl ether groups. Suitable vinyl ether compounds from which the vinyl ether terminal groups may be derived include hydroxy functional vinyl ethers. Examples of suitable compounds include, but are not limited to 2-hydroxyethyl vinyl ether, 4-hydroxybutyl vinyl ether, cyclohexanedimethanol monovinyl ether, diethylene glycol monovinyl ether, 1,6-hexanediol monovinyl ether and 3-aminopropyl vinyl ether.

Alternatively, the vinyl ether terminal groups may be derived from an amino functional vinyl ether, in which case vinyl ether urea capped polyurethanes may be obtained. For example, the reaction product of an isocyanate terminated block copolymer and 3-aminopropyl vinyl ether forms the following urea linkage:

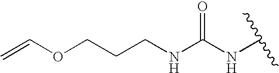

In some embodiments of the present invention, the polyurethane block copolymer may be more specifically represented by the following formula (III):

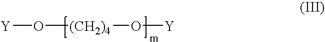

where Y represents hard segments terminated by vinyl ether groups and nm is 1-70.

In some embodiments, Y may be represented by the following structure:

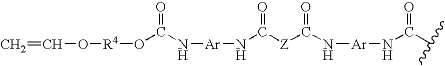

where R⁴ is C₁₋₆ alkyl

In the structure provided for Y in formula (III) above, Ar may be an aryl group derived from a polyisocyanate. Ar may be derived from any of the exemplary polyisocyanates provided above.

Additionally, Z may be a divalent radical formed from an aromatic, heterocyclic or cycloaliphatic polyol, as described above. Desirably, Z is selected from the following:

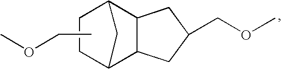

which is a divalent radical of HMTD;

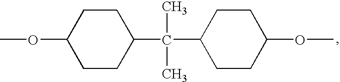

which is a divalent radical of hydrogenated bisphenol A; and

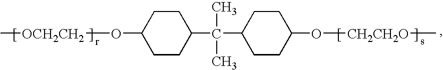

where r and s are independently selected from 1-3, and which is a divalent radical of ethoxylated hydrogenated bisphenol A.

The present invention also relates to compositions including the vinyl ether terminated polyurethane block copolymers described above. More specifically, the compositions may include a polyurethane block copolymer of formulas (I), (II) or (III), a reactive diluent and at least one curing initiator.

In some embodiments, the compositions may contain the polyurethane block copolymer in amounts of about 10% to about 90% by weight of the composition, more desirably about 20% to about 60% by weight. It also is contemplated to include more than one block copolymer in the compositions.

A variety of vinyl ether and/or acrylate reactive diluents may be employed. Desirably, the reactive diluent included in the compositions is a “hybrid” diluent because it includes at least one vinyl ether or 1-alkenyl ether group and at least one (meth)acrylate group. In some embodiments, the reactive diluent may be represented by the following formula (IV):

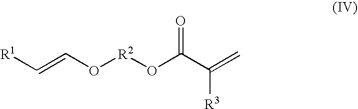

where R¹ is selected from hydrogen; aliphatic C₁₋₆ alkyl; and C₁₋₆cycloalkyl;

R² is selected from C₂₋₂₀ alkylene; C₂₋₂₀ hydrocarbon diradical; and polyalkylene oxide; and

R³ is selected from hydrogen and methyl.

The reactive diluent may have a molecular weight of less than about 1500. Desirably, the molecular weight is less than about 750, more desirably less than about 500. The viscosity of the reactive diluent may be less than about 5000 cps at 25° C., more desirably less than about 2000 cps and even more desirably about 50-500 cps.

Examples of suitable reactive diluents include, but are not limited to: 2-(2′-vinyloxyethoxy)ethyl acrylate, 2-(2′-vinyloxyethoxy)ethyl methacrylate, 2-vinyloxyethyl acrylate, 2-vinyloxyethyl methacrylate, 2-(2′-prop-1-enyloxyethoxy)ethyl methacrylate, 2-(2′-prop-1-enyloxyethoxy)ethyl acrylate, and combinations thereof.

The reactive diluent may be present in amounts of about 5% to about 60% by weight of the composition. Desirably, the reactive diluent may be present in amounts of about 15% to about 50%, more desirably about 15% to about 30% by weight of the composition.

The compositions of the present invention also may contain one or more curing initiators. Desirably, the compositions cure upon exposure to visible light, i.e., irradiation at about 470 nm. The compositions also may be cured by exposure to other energy sources, including, but not limited to, UV irradiation and heat. Accordingly, the curing initiator(s) incorporated into the compositions of the present invention may be a UV photoinitiator, visible light photoinitiator, thermal initiator, redox initiator or any combination thereof.

Desirably, the curing intiator(s) is a visible light photoinitiator. Examples of suitable visible light photoinitiators include, but are not limited to: camphorquinone; two-component initiators including a dye and electron donor, three-component initiators including a dye, electron donor and oxidant; and combinations thereof.

Suitable dyes include, but are not limited to: camphorquinone, 5,7-diiodo-3-butoxy-6-fluorone, rose bengal, riboflavin, cosin Y, benzil, fluorone dyes, benzil derivatives, ketocoumarins, acridine dyes, benzoflavin and combinations thereof.

Suitable electron donors include, but are not limited to: methyldiethanolamine, dimethyl-p-toluidine, N,N-dimethylaminoethyl methacrylate, ethyl 4-dimethylaminobenzoate and combinations thereof.

Suitable oxidants include, but are not limited to: bis(trichloromethyl) triazines, onium salts and combinations thereof. Examples of onium salts include sulfonium and iodonium salts.

Examples of suitable UV initiators include, but are not limited to: phosphine oxides, benzophenone and substituted benzophenones, acetophenone and substituted acetophenones, benzoin and its alkyl ethers and combinations thereof.

In addition to a UV photoinitiator, visible light photoinitiator, thermal initiator and/or a redox initiator, some embodiments also may include a cationic initiator. Cationic initiators include, but are not limited to, oxidants as provided above, such as diaryliodonium salts and dialkylphenacyl sulfonium salts, optionally with a sensitizing dye, such as the dyes provided above. The use of a cationic initiator in the absence of a sensitizing dye is described in U.S. Pat. No. 4,058,400, which is incorporated by reference herein in its entirety.

The curing initiator(s) may be present in amounts of about 0.01% to about 10% by weight of said composition, more desirably about 0.01% to about 5% by weight of the composition.

In some embodiments of the present invention, the compositions also may contain optional additives including thiols, organic acids, as described in co-pending application entitled “Liquid Stable Thiol Acrylate Compositions” and filed on evendate herewith (Express Mail No. EV481316321US), which is incorporated by reference herein, additional monomers, such as, but not limited to, N,N-dimethylacrylamide (N,N-DMAA) and partially acrylated bisphenol A epoxy (EBECRYL 3605), free radical scavengers, such as, but not limited to, 4-methoxy phenol, hydroquinone, 1,4-naphthoquinone and/or 2,6-di-tert-butyl-4-methylphenol, stabilizers, inhibitors, oxygen scavenging agents, fillers, dyes, colors, pigments, additional adhesion promoters, plasticizers, toughening agents, reinforcing agents, fluorescing agents, rheological control agents, wetting agents and combinations thereof.

More specifically, in some embodiments it may be desirable to include a thiol to improve the adhesion and surface cure properties of the composition. In addition, in compositions including cationic initiators, thiols may provide the added benefit of reducing or eliminating scorching, i.e., surface charring and/or discoloration during cure.

Examples of suitable thiols include, but are not limited to: pentaerythritol tetrakis(3-mercaptopropionate), ethoxylated pentaerythritol tetrakis(3-mercaptopropionate), pentaerythritol tetrakis(2-mercaptoacetate), tripentaerythritol octakis(thioglycollate), dipentaerythritol hexakis(thioglycollate) and mercapto-propionates and acetates prepared by oligomerization techniques, such as those described in Example 12 of U.S. Pat. No. 5,459,175, which is incorporated by reference herein in its entirety. More specifically, such oligomers may be prepared by the addition reaction of a multifunctional mercaptopropionate or mercaptoacetate with a stoichiometric deficiency of a dialkene or multi-alkenyl monomer that is not subject to extensive homopolymerization during the thiol-ene addition reaction.

When incorporated into the compositions of the present invention, thiols may be present in amounts of about 0.25% to about 11% by weight of the composition, more desirably about 0.25% to about 5% by weight.

In some embodiments, the compositions of the present invention include the reaction product of the afore-mentioned components. More specifically, the composition may include the reaction product of a polyurethane block copolymer of formula (I), (II) or (III), a reactive diluent including at least one vinyl ether or 1-alkenyl ether group and at least one (meth)acrylate group, and at least one curing initiator.

In other embodiments of the present invention, the polyurethane block copolymer included in the compositions may be a (meth)acrylate terminated block copolymer. In particular, such compositions may include a polyurethane block copolymer represented by formula (I), where D comprises a (meth)acrylate group and all other variable are as defined above. The compositions also may include a reactive diluent having at least one vinyl ether or 1-alkenyl ether group and at least one (meth)acrylate group and one or more curing initiators, as described above. Alternatively, in some embodiments, the compositions may contain the reaction product of these components.

In other embodiments, the compositions may include a (meth)acrylate resin, which is not a block copolymer, as well as the hybrid reactive diluent and curing intiator(s), as described above. Examples of suitable (meth)acrylate resins include, but are not limited to: CN98S (difunctional polyester-based resin), CN934 (trifunctional polyether-based resin) and CN971 (trifunctional polyether-based resin) (all commercially available from Sartomer Company, Inc.), Photomer 5430 (tetra functional polyester-based resin), Photomer 6010 (difunctional aliphatic urethane resin) and Photomer 6623 (hexafunctional aliphatic urethane resin) (all commercially available from Cognis); mid BR-990 (trifunctional aliphatic urethane resin), BR 374 (difunctional polyether-based resin) and BR 571 (difunctional aliphatic urethane resin) (all commercially available from Bomar Specialties Co.).

Combinations of any of the resins described above also may be incorporated into the compositions with the reactive diluent and curing initiator(s).

The present invention also relates to methods of preparing and using the compositions described above. In some embodiments, the compositions may be prepared by first providing a polyurethane block copolymer represented by the following formula (V):

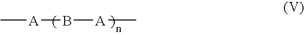

where A, B and n are as defined above.

This block copolymer is reacted with a vinyl ether compound to form a vinyl ether terminated block copolymer. The vinyl ether functionalized copolymer may be combined with a reactive diluent, as described above, to form the composition. Any of the optional components described above may be added to the composition, as desired.

In accordance with another method, the compositions may be prepared by first providing a polyurethane block copolymer having at least one hard segment and at least one soft segment and which is terminated with (meth)acrylate groups. This (meth)acrylate terminated block copolymer then may be combined with a reactive diluent, as described above, to form the composition. Any of the optional components described above may be added to the composition, as desired.

The compositions of the present invention may be used, for example, to seal or bond substrates, such as, but not limited to, gaskets. In gasketing applications, the composition may be applied to one of the substrates which will form part of the gasket, cured or at least partially cured, and then joined to a second substrate to form the gasket assembly. Such gasketing applications include, for example, form-in-place gaskets. Coatings, adhesive joints and potting compositions may also be made from the inventive compositions. For instance, the compositions may be applied to a substrate and subjected to curing conditions. The compositions may also be used to seal together substrates by applying the composition to at least one of two substrate surfaces, mating the substrate surfaces in an abutting relationship to form an assembly, and exposing the composition to an energy source, such as photoradiation, heat or combinations thereof, to effect cure. The substrates should be maintained in the abutting relationship for a time sufficient to effect curing.

### Synthesis

The block copolymers of the present invention may be formed by at least two synthetic approaches, each of which being described below.

### Scheme 1

In a reaction scheme employing a diisocyante and a difunctional polyol, two moles of a polyisocyanate (“I”) may be reacted with one mole of an aromatic, heterocyclic or cycloaliphatic polyol (“D”) to cap the polyol with —NCO groups, thereby forming a rigid, or hard, segment (“A” Stage Product). The “A” Stage Product may be reacted with a stoichiometric deficiency of a polyether or polyester polyol (“Z”), which is a flexible, or soft, segment, to prepare a block copolymer containing alternating hard and soft segments (“B” Stage Product). This reaction may occur in the presence of a catalyst. More specifically, the ratio of isocyanate end groups in I-D-I to hydroxyl groups in Z may be less than 2:1. Desirably, the ratio is about 1.5:1 to about 1.9:1. Varying this ratio provides different degrees of chain extension in the polymer block. It would be understood by those of ordinary skill in the art that branching may be included in the soft segment, and the ratios of components would be adjusted accordingly. Additionally, one skilled in the art would understand that the ratios are selected such that the system does not gel undesirably.

The “B” Stage block copolymer may be further reacted with vinyl ether to cap the block copolymer with vinyl ether groups (“C” Stage Product). This reaction may occur in the presence of a catalyst.

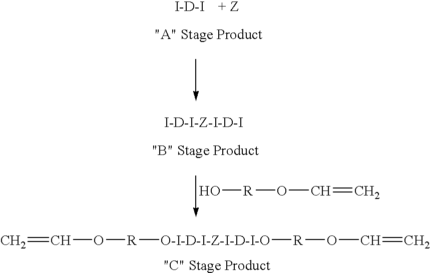

where R is C₁₋₆ alkyl.

For example, as represented below, 2,4-tolylene diisocyanate (“2,4-TDI”) may be reacted with 4,8-bis(2-hydroxymethyl)tricyclo[5.2.1.0^{2,6}]decane (“HMTDD”) to cap the polyol with —NCO groups (“A” Stage Product). The “A” Stage Product may be reacted with poly(tetramethylene ether) diol (“pTfIF”) to prepare a polyurethane block copolymer (“B” Stage Product). This reaction may occur in the presence of dibutyl tin dilaurate catalyst. The “B” Stage polyurethane block copolymer may be further capped with vinyl ether groups (“C” Stage Product). This reaction also may occur in the presence of dibutyl tin dilaurate catalyst.

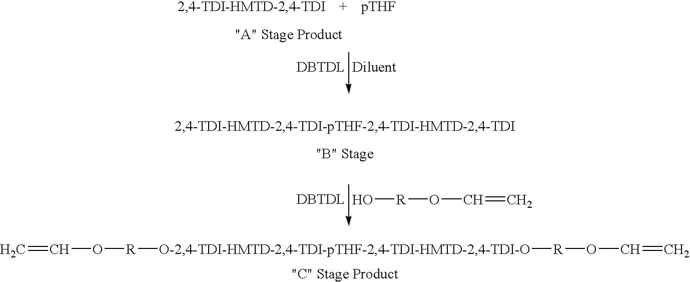

### Scheme 2

In a reaction scheme employing a diisocyante and a difunctional polyol, two moles of a polyisocyanate (“I”) may be reacted with one mole of an aromatic, heterocyclic or cycloaliphatic polyol (“D”) to cap the polyol with —NCO groups, thereby forming a rigid, or hard, segment (“A” Stage Product). The “A” Stage Product may be reacted with slightly less than ½ mole (meth)acrylate to cap one end of the segment (“B” Stage Product). More specifically, this reaction may proceed with a slight molar excess of isocyanate end groups in I-D-I as compared to (meth)acrylate groups, which may provide chain extension and ensure that all (meth)acrylate is consumed. Consumption of the acrylate is particularly desirable in compositions in which hydroxyethyl acrylate (an allergen) is used. This reaction may occur in the presence of a catalyst.

The “B” Stage Product may be further reacted with one mole of a polyether or polyester polyol (“Z”), which is a flexible, or soft, segment, to prepare a (meth)acrylate capped block copolymer containing alternating hard and soft segments (“C” Stage Product). This reaction may occur in the presence of a catalyst.

It would be understood by those of ordinary skill in the art that branching may be included in the soft segment, and the ratios of components would be adjusted accordingly. Additionally, one skilled in the art would understand that the ratios are selected such that the system does not gel undesirably.

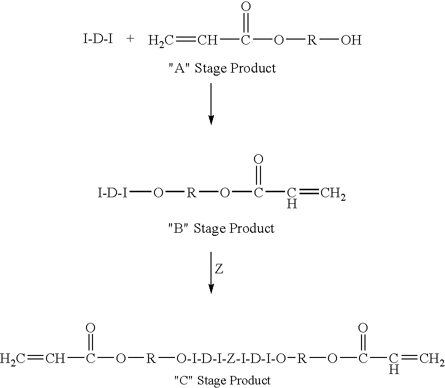

where R is C₁₋₆ alkyl.

For example, as represented below, 2,4-tolylene diisocyanate (“2,4-TDI”) may be reacted with HMTD to cap the polyol with —NCO groups (“A” Stage Product). The “A” Stage Product may be reacted with hydroxyethyl acrylate to further cap the segment (“B” Stage Product). The reaction may occur in the presence of dibutyl tin dilaurate catalyst. The “B” Stage Product may be further reacted with poly(tetramethylene ether) diol (“pTHF”) to prepare an acrylate capped polyurethane block copolymer (“C” Stage Product). This reaction also may occur in the presence of dibutyl tin dilaurate catalyst.

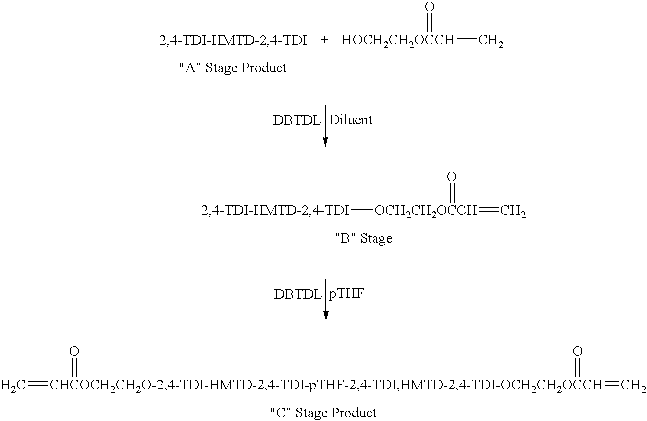

Reaction scheme 2 is not limited to (meth)acrylate functionality and may be used to prepare vinyl ether terminated block copolymers as well as block copolymers having both (meth)acrylate and vinyl ether functionality.

It would be understood by one of ordinary skill in the art that the I, D, Z, TDI, HMTD and pTHF variables used in the schemes above encompass radicals of these components.

### EXAMPLES

### Example 1

A composition of the present invention was prepared in accordance with the following process, which followed reaction scheme 1, as described above. The composition contained a (meth)acrylate terminated block copolymer in a vinyl ether reactive diluent.

Into a reaction flask was added HMTD, cyclohexanedimethanol divinyl ether (reactive diluent), methacrylic acid, tetrakis (methylene (3,5-di-t-butyl-4-hydroxyhydrocinnamate)) (commercially available as IRGANOX 1010), methyl hydroquinone (MeHQ), isophorone diisocyanate (IPDI), and dibutyl tin dilaurate (DBTDL (I)), in the amounts provided in Table 1 below. The reaction mixture was heated to 75° C. under dry air. An exotherm was observed to form during the reaction at a temperature of 80° C. After the initial reaction, which produced a rigid segment (“A” Stage Product), the reaction mixture was maintained at 75° C. for 1.5 hours while stirring.

To the reaction mixture was added poly(tetramethylene ether) diol (commercially available as POLYMEG 2000) and dibutyl tin dilaurate (DBTDL (II)), in the amounts provided in Table 1. The temperature was maintained at 75° C. while stirring for two hours, which produced a block copolymer (“B” Stage Product).

The reaction mixture was titrated to determine the quantity of hydroxyethyl methacrylate to be added. Then the calculated amount of hydroxyethyl methacrylate (“HEMA”) and bismuth octoate were added in the amounts provided in Table 1. The temperature was maintained at 75° C. while stirring for three hours, which yielded 411.7 g of the methacrylate capped polyurethane block copolymer (“C” Stage Product) in the vinyl ether diluent.

TABLE 1

| | | | | | Found | Equiv. | |
|---|---|---|---|---|---|---|---|
| Component | MW | Weight (g) | Moles | Theo. Equiv. | Equiv. | Ratio | Wt % |
| HMTD | 201.83 | 35.10 | 0.180 | 0.360 | 0.360 | 1.000 | 8.15 |
| IPDI | 222.29 | 79.96 | 0.360 | 0.719 | 0.719 | 2.000 | 18.58 |
| Polymeg 2000 | 1941.52 | 207.60 | 0.107 | 0.215 | 0.215 | 0.597 | 48.23 |
| HEMA | 130.14 | 18.41 | 0.141 | 0.168 | 0.141 | 0.393 | 4.28 |
| DBTDL (I) | | 0.17 | | | | | 0.04 |
| DBTDL (II) | | 0.17 | | | | | 0.04 |
| Bismuth octoate | | 0.17 | | | | | 0.04 |
| IRGANOX 1010 | | 0.17 | | | | | 0.04 |
| MeHQ | | 0.17 | | | | | 0.04 |
| Cyclohexane- | | 86.12 | | | | | 20.01 |
| dimethanol | | | | | | | |
| divinyl ether | | | | | | | |
| Methacrylic Acid | | 2.42 | | | | | 0.56 |

### Example 2

A composition of the present invention was prepared in accordance with the following process, which followed reaction scheme 1, as described above. The composition contained a vinyl ether terminated block copolymer in a dimethyl acrylamide reactive diluent.

Into a reaction flask was added HMTD, N,N-DMAA, methacrylic acid, tetrakis (methylene (3,5-di-t-butyl-4-hydroxyhydrocinnamate)) (commercially available as IRGANOX 1010), methyl hydroquinone (MeHQ), isophorone diisocyanate (IPDI), and dibutyl tin dilaurate (DBTDL (I)), in the amounts provided in Table 2 below. The reaction mixture was heated to 75° C. under dry air. The reaction exothermed to about 80° C. After the initial reaction, which produced a rigid segment (“A” Stage Product), the reaction mixture was maintained at 75° C. for 1.5 hours while stirring.

To the reaction mixture was added poly(tetramethylene ether) diol (commercially available as POLYMEG 2000) and dibutyl tin dilaurate (DBTDL (II)), in the amounts provided in Table 2. The temperature was maintained at 75° C. while stirring for two hours, which produced a block copolymer (“B” Stage Product).

The reaction mixture was titrated to determine the quantity of 2-hydroxyethyl vinyl ether to be added. Then the calculated amount of 2-hydroxyethyl vinyl ether and bismuth octoate were added in the amounts provided in Table 2. The temperature was maintained at 75° C. while stirring for three hours, which yielded 406.7 g of the vinyl ether terminated polyurethane block copolymer (“C” Stage Product) in the dimethyl acrylamide diluent. This block copolymer contains no isocyanate, as was determined by infrared spectroscopy.

TABLE 2

| | | Weight | | Theo. | Found | Equiv. | |
|---|---|---|---|---|---|---|---|
| Component | MW | (g) | Moles | Equiv. | Equiv. | Ratio | Wt % |
| HMTD | 201.83 | 35.21 | 0.180 | 0.361 | 0.361 | 1.000 | 8.26 |
| IPDI | 222.29 | 80.21 | 0.361 | 0.722 | 0.722 | 2.000 | 18.81 |
| Polymeg 2000 | 1941.52 | 208.25 | 0.107 | 0.215 | 0.215 | 0.597 | 48.84 |
| 2-Hydroxyethyl Vinyl | 88.00 | 14.82 | 0.168 | 0.168 | 0.168 | 0.467 | 3.48 |
| Ether | | | | | | | |
| DBTDL (I) | | 0.17 | | | | | 0.04 |
| DBTDL (II) | | 0.17 | | | | | 0.04 |
| Bismuth octoate | | 0.17 | | | | | 0.04 |
| IRGANOX 1010 | | 0.17 | | | | | 0.04 |
| MeHQ | | 0.17 | | | | | 0.04 |
| N,N-DMAA | | 84.62 | | | | | 19.85 |
| Methacrylic Acid | | 2.40 | | | | | 0.56 |

### Example 3

The process described in Example 2 was followed except that 2-(2′-vinyloxyethoxy)ethyl acrylate (FX-VEEA) was employed instead of N,N-dimethyl acrylamide (N,N-DMAA) in the first step and the component quantities were as indicated in Table 3 below. The composition contained a vinyl ether terminated block copolymer in a 2(2′-vinyloxyethoxy)ethyl acrylate (FX-VEEA) reactive diluent.

TABLE 3

| | | Weight | | Theo. | Found | Equiv. | |
|---|---|---|---|---|---|---|---|
| Component | MW | (g) | Moles | Equiv. | Equiv. | Ratio | Wt % |
| HMTD | 201.83 | 35.17 | 0.180 | 0.360 | 0.360 | 1.000 | 8.27 |
| IPDI | 222.29 | 80.12 | 0.360 | 0.721 | 0.721 | 2.000 | 18.85 |
| Polymeg 2000 | 1941.52 | 208.01 | 0.107 | 0.215 | 0.215 | 0.597 | 48.93 |
| 2-Hydroxyethyl Vinyl | 88.00 | 13.83 | 0.157 | 0.168 | 0.157 | 0.436 | 3.25 |
| Ether | | | | | | | |
| DBTDL (I) | | 0.17 | | | | | 0.04 |
| DBTDL (II) | | 0.17 | | | | | 0.04 |
| Bismuth octoate | | 0.17 | | | | | 0.04 |
| IRGANOX 1010 | | 0.26 | | | | | 0.06 |
| MeHQ | | 0.26 | | | | | 0.06 |
| FX-VEEA | 186.00 | 84.52 | 0.454 | | | | 19.88 |
| Methacrylic Acid | | 2.40 | | | | | 0.57 |

This Example yielded 407.3 g of the vinyl ether terminated polyurethane block copolymer (“C” Stage Product) in the 2-(2′-vinyloxyethoxy)ethyl acrylate diluent. This block copolymer contains no isocyanate, as was determined by infrared spectroscopy.

### Example 4

The process described in Example 2 was followed except that divinyl ether (DVE-3) was employed instead of N,N-dimethyl acrylamide (N,N-DMAA) in the first step and 2-hydroxybutyl vinyl ether was used instead of 2-hydroxyethyl vinyl ether in the third step. The component quantities were as indicated in Table 4 below. The composition contained a vinyl ether terminated block copolymer in a divinyl ether reactive diluent.

TABLE 4

| | | Weight | | Theo. | Found | Equiv. | |
|---|---|---|---|---|---|---|---|
| Component | MW | (g) | Moles | Equiv. | Equiv. | Ratio | Wt % |
| HMTD | 201.83 | 39.95 | 0.205 | 0.409 | 0.409 | 1.000 | 8.71 |
| IPDI | 222.29 | 91.01 | 0.409 | 0.819 | 0.819 | 2.000 | 19.84 |
| Polymeg 2000 | 1941.52 | 236.28 | 0.122 | 0.244 | 0.244 | 0.597 | 51.51 |
| 2-Hydroxybutyl Vinyl | 116.16 | 19.18 | 0.165 | 0.191 | 0.165 | 0.403 | 4.18 |
| Ether | | | | | | | |
| DBTDL (I) | | 0.19 | | | | | 0.04 |
| DBTDL (II) | | 0.19 | | | | | 0.04 |
| Bismuth octoate | | 0.19 | | | | | 0.04 |
| 3-228 | | 0.30 | | | | | 0.06 |
| MeHQ | | 0.30 | | | | | 0.06 |
| DVE-3 | 202.00 | 68.72 | 0.34 | | | | 14.98 |
| Methacrylic Acid | | 2.40 | | | | | 0.52 |

This Example yielded 437.9 g of the vinyl ether terminated polyurethane block copolymer (“C” Stage Product) in the divinyl ether diluent. This block copolymer contains no isocyanate, as was determined by infrared spectroscopy.

### Example 5

A composition of the present invention was prepared in accordance with the following process, which followed reaction scheme 2, as described above. The composition contained an acrylate terminated block copolymer in a 2-(2′-vinyloxyethoxy)ethyl acrylate (FX-VEEA) reactive diluent.

Into a reaction flask was added HMTD, vinyl ether ethoxyacrylate, tetrakis (methylene (3,5-di-t-butyl-4-hydroxyhydrocinnamate)) (commercially available as IRGANOX 1010), methyl hydroquinone (MeHQ) and 2,4-tolylene diisocyanate (2,4-TDI), in the amounts provided in Table 5 below. While stirring for 1.5 hours, the reaction mixture was heated to 75° C. under dry air.

Hydroxyethyl acrylate and dibutyl tin dilaurate (DBTDL (I)) were added to the reaction mixture in the amounts indicated in Table 5 and the reaction exothermed to 80° C. After the initial reaction, which produced a “B” Stage Product, the reaction mixture was stirred for two hours at 75° C.

The reaction mixture was titrated to determine the quantity of poly(tetramethylene ether) diol (pTHF) to be added. Then the calculated amount of poly(tetramethylene ether) diol and dibutyl tin dilaurate (DBTDL (II)) were added in the amounts provided in Table 5 and the reaction mixture was stirred for three hours. This yielded 452.9 g of the acrylate capped polyurethane block copolymer (“C” Stage Product) in the 2-(2′-vinyloxyethoxy)ethyl acrylate diluent. This block copolymer contains 0.05 weight % isocyanate, as was determined by infrared spectroscopy.

TABLE 5

| | | Weight | | | Found | Equiv. | |
|---|---|---|---|---|---|---|---|
| Component | MW | (g) | Moles | Theo. Equiv. | Equiv. | Ratio | Wt % |
| HMTD | 201.83 | 44.96 | 0.230 | 0.461 | 0.461 | 1.000 | 9.67 |
| 2,4-TDI | 174.16 | 80.25 | 0.461 | 0.922 | 0.922 | 2.000 | 17.27 |
| Hydroxyethyl | 116.20 | 21.58 | 0.186 | 0.186 | 0.186 | 0.403 | 4.64 |
| Acrylate | | | | | | | |
| Polymeg 2000 | 1941.52 | 234.78 | | 0.275 | 0.243 | 0.597 | 50.53 |
| DBTDL (I) | | 0.10 | | | | | 0.02 |
| DBTDL (II) | | 0.10 | | | | | 0.02 |
| IRGANOX 1010 | | 0.21 | | | | | 0.04 |
| MeHQ | | 0.21 | | | | | 0.04 |
| FX-VEEA | 186.00 | 82.54 | 0.44 | | | | 17.77 |

### Example 6

A composition of the present invention was prepared in accordance with the following process, which followed reaction scheme 1, as described above. The composition contained a vinyl ether terminated block copolymer in a 2-(2′-vinyloxyethoxy)ethyl acrylate (FX-VEEA) reactive diluent.

Into a reaction flask was added HMTD, vinyl ether ethoxyacrylate, methacrylic acid, tetrakis (methylene (3,5-di-t-butyl-4-hydroxyhydrocinnamate)) (commercially available as IRGANOX 1010), methyl hydroquinone (MeHQ) and 2,4-tolylene diisocyanate (2,4-TDI), in the amounts provided in Table 6 below. The reaction mixture was heated to 75° C. under dry air. The reaction exothermed to about 82° C. After the initial reaction, which produced a rigid segment (“A” Stage Product), the reaction mixture was maintained at 75° C. for 1.5 hours while stirring.

To the reaction mixture was added poly(tetramethylene ether) diol (commercially available as POLYMEG 2000) and dibutyl tin dilaurate (DBTDL (I)), in the amounts provided in Table 6. The temperature was maintained at 75° C. while stirring for two hours, which produced a block copolymer (“B” Stage Product).

The reaction mixture was titrated to determine the quantity of 2-hydroxybutyl vinyl ether to be added. Then the calculated amount of 2-hydroxybutyl vinyl ether and dibutyl tin dilaurate (DBTDL (II)) were added in the amounts provided in Table 6. The temperature was maintained at 75° C. while stirring for two hours, which yielded 448 g of the vinyl ether terminated polyurethane block copolymer (“C” Stage Product) in the 2-(2′-vinyloxyethoxy)ethyl acrylate diluent. This block copolymer contains 0.09 wt. % isocyanate, as was determined by infrared spectroscopy.

TABLE 6

| | | Weight | | Theo. | Found | Equiv. | |
|---|---|---|---|---|---|---|---|
| Component | MW | (g) | Moles | Equiv. | Equiv. | Ratio | Wt % |
| HMTD | 201.83 | 43.30 | 0.222 | 0.444 | 0.444 | 1.000 | 9.20 |
| 2,4-TDI | 174.16 | 77.28 | 0.444 | 0.887 | 0.887 | 2.000 | 16.41 |
| Polymeg 2000 | 1941.52 | 256.09 | 0.132 | 0.265 | 0.265 | 0.597 | 54.39 |
| 2-Hydroxybutyl Vinyl | 116.16 | 20.39 | 0.176 | 0.207 | 0.176 | 0.396 | 4.33 |
| Ether | | | | | | | |
| DBTDL (I) | | 0.10 | | | | | 0.02 |
| DBTDL (II) | | 0.10 | | | | | 0.02 |
| IRGANOX 1010 | | 0.29 | | | | | 0.06 |
| MeHQ | | 0.29 | | | | | 0.06 |
| FX-VEEA | 186.00 | 70.71 | 0.38 | | | | 15.02 |
| Methacrylic Acid | | 2.30 | | | | | 0.49 |

### Example 7

The block copolymers prepared in Examples 1-6 were formulated into visible light curable adhesives by addition of a visible light photoinitiator (470 nm-sensitive) and, optionally, reactive diluents and monomers, as indicated in Tables 7 and 8 below. Two principal techniques were used to characterize the resulting formulations: surface tack and block shear adhesion. The results of these tests are shown in Tables 7 and 8.

Surface tack was rated on a scale of 1 to 5, with 5 being tack-free; a description of the ratings is as follows:
1. Completely uncured
2. Gelled bulk, uncured surface
3. Cured bulk; surface leaves residue on glove when contacted and typically retains all silicon carbide grit (“SiC”) when dusted
4. Surface leaves no residue but feels sticky and typically retains 50-60% SiC
5. Surface is dry, tack-free, and retains ≦10% SiC

Surface cure was typically evaluated on samples that had been irradiated for 60 seconds with a 470 nm “Demetron” LED at a source-to-sample distance of 10 mm.

Block shear adhesion was measured using polycarbonate specimens (1×1×¼″) the specimens were assembled with no induced gap and with a ½″ overlap. Since the usual Demetron light source has a diameter of only 1 cm, two Demetrons were placed side by side to achieve cure of the ½×1″ bond line. Alternatively, a conveyorized array system or a 450 nm LED array could be used; due to its more uniform intensity, bonds cured with the array typically displayed higher adhesive strength. Polycarbonate block shear specimens were assembled and cured with four passes through a conveyorized 470 nm LED source; each pass exposed the specimens to approximately 30 seconds of light at a maximum intensity of 85 mW/cm². The resulting block shear adhesion was measured according to ASTM D4501, “Shear Strength of Adhesive Bonds between Rigid Substrates by the Block-Shear Method,” which is incorporated by reference herein, using a 20 kN load cell. Adhesive strength was measured in units of pounds per square inch of compressive pressure needed to break the bond.

A strain rate of 0.5 in/min was used in initial testing, the results of which are shown in Table 7. Subsequent testing used a strain rate of 0.05 in/min, in accordance with ASTM D4501, referred to above, the results of which are shown in Table 8. The lower strain rate typically results in lower measured adhesive strengths.

TABLE 7

| Example | Backbone | Additional Components | Surface | Adhesion |
|---|---|---|---|---|
| 1 | aliphatic | DVE-3¹, N,N-DMAA² | 2 | 156 |
| 1 | aliphatic | HEMA³, TMPTMA⁴, FX-VEEM⁵, DVE-3 | 1-2 | n.d. |
| 1 | aliphatic | DVE-3, TMPTMA, FX-VEEM | 1-2 | n.d. |
| 2 | aliphatic | FX-VEEA⁶, DVE-3 | 2 | 76 |
| 3 | aliphatic | FX-VEEA, TMPTA⁷ | 4 | 1036 |
| 3 | aliphatic | PETMP⁸, FX-VEEA, TMPTA | 4 | 1198 |
| 3 | aliphatic | PETMP, FX-VEEA, TMPTA, UC1561⁹ | 4 | 1562 |
| 3 | aliphatic | PETMP, FX-VEEA, TMPTA, N,N-DMAA | 3 | 362 |
| 3 | aliphatic | PETMP, DVE-3, HDDA¹⁰, TMPTA | 2-3 | 277 |
| 3 | aliphatic | PETMP, DVE-3, SR344¹¹, TMPTA | 3 | 165 |
| 4 | aliphatic | PETMP, FX-VEEA, TMPTA | 3 | 401 |
| 4 | aliphatic | PETMP, FX-VEEA, TMPTA, UC1561 | 3 | 840 |
| 5 | aromatic | FX-VEEA, TMPTA, UC1561, PETMP | 5 | 1560 |
| 5 | aromatic | FX-VEEA, TMPTA, Epalloy 5000¹², PETMP | 3 | 840 |
| 5 | aromatic | FX-VEEA, TMPTA, Eb3605¹³, PETMP | 5 | 1396 |
| 5 | aromatic | FX-VEEA, TMPTA, bisGMA¹⁴, PETMP | 3-4 | 1080 |
| 5 | aromatic | DMPT¹⁵; FX-VEEA, TMPTA, bisGMA, PETMP | 4 | 1686 |
| 5 | aromatic | DMPT; FX-VEEA, TMPTA, Eb3605, PETMP | 4 | 1220 |
| 5 | aromatic | FX-VEEA, TMPTA, xs Eb3605, PETMP | 5 | 1467 |
| 6 | aromatic | FX-VEEA, TMPTA, Eb3605, PETMP | 5 | 1018 |
| 6 | aromatic | FX-VEEA, TMPTA, Eb3605 + bGMA, PETMP | 3 | 735 |

¹Divinyl ether
²N,N-dimethyl acrylamide
³Hydroxyethyl methacrylate
⁴Trimethylolpropane trimethacrylate
⁵2-(2′-vinyloxyethoxy)ethyl methacrylate
⁶2-(2′-vinyloxyethoxy)ethyl acrylate
⁷Trimethylolpropane triacrylate
⁸Pentaerythritol tetrakis(3-mercaptopropionate)
⁹Partially acrylated bisphenol epoxy (available as Uvacure 1561 from UCB)
¹⁰1,6-hexanediol diacrylate
¹¹Polyethylene glycol (400) diacrylate (available from Sartomer Company, Inc.)
¹²Bisphenol A epoxy resin
¹³Partially acrylated bisphenol A epoxy
¹⁴2,2-bis[4-(2-hydroxy-3-methacryloxypropoxy)phenyl] propane
¹⁵N,N-dimethyl-p-toluidine

TABLE 8

| Example | Additional Components | Surface | Adhesion | Light Source |
|---|---|---|---|---|
| 5 | FX-VEEA, TMPTA, Eb3605, PETMP | 5 | 880 | 2 × Demetron |
| 6 | FX-VEEA, TMPTA, Eb3605, PETMP | 5 | 1566 | 450 nm array |
| 5 | FX-VEEA, TMPTA, Eb3605 | 3 | 512 | 2 × Demetron |
| 5 | FX-VEEA, TMPTA, N,N-DMAA, Eb3605, | 5 | 676 | 2 × Demetron |
| | PETMP | | | |
| 6 | FX-VEEA, TMPTA, Eb3605, PP150-TMP¹ | 5 | 1170 | 450 nm array |

¹Ethoxylated pentaerythritol (PP150) tetrakis(3-mercaptopropionate)

### Comparative Example 8

The following comparative composition was prepared on a 10 g scale and mixed in a DAC 400 FVZ speed mixer: 1.24 wt % p-octyloxyphenylphenyliodonium hexafluoroantimonate (initiator), 0.50 wt % camphorquinone (initiator), 0.13 wt % N,N-diethylaminobenzoate (EMBO) (initiator), 5.16 wt % trimethylolpropane triacrylate (TMPTA), 42.61 wt % FX-VEEA, and 50.36 it % vinyl ether-capped aliphatic block copolymer with vinyl ether ethoxyacrylate diluent, prepared in Example 3. A thiol component was not included.

Photocurability was tested using a Demetron 470 nm light source. With the Demetron an intensity of approximately 110 mW/cm² is produced at 10 mm from the source. Single drops of sample were dropped from a wooden stick onto glass slides and continuously irradiated with the Demetron for 60 see; results are shown in Table 9 below.

TABLE 9

| | Distance from source: | | |
|---|---|---|---|
| | 10 mm | 12 mm | 22 mm |
| Result: | Scorched within 6 sec; | Scorched within 6 sec; | Tacky, poorly |
| | tack-free surface after | tack-free surface after | cured surface |
| | 60 sec | 60 sec | (not scorched) |

Pulsing the Demetron for 2-second intervals at the 10 mm sample-to-source distance was found to effectively avoid scorching while giving a reasonably tack free surface after a total irradiation time of 30 seconds. However, the resulting cure profile is complex and requires a longer net time (including dark periods between pulses) than is desirable.

Using a much lower intensity LED array (470 nm, intensity ˜15 mW/cm² at the sample-to-source distance used), a sample bulk cured within 60 seconds without scorching but failed to give an acceptable tack-free surface.

### Comparative Example 9

The following comparative composition was prepared on a 10 g scale and mixed in a DAC 400 FVZ speed mixer: 1.27 wt % p-octyloxyphenylphenyliodonium hexafluoroantimonate (initiator), 0.51 wt % camphorquinone (initiator), 5.12 wt % TMPTA, 42.64 wt % FX-VEEA and 50.46 wt % vinyl ether-capped aliphatic block copolymer with vinyl ether ethoxyacrylate diluent, prepared in Example 3. A thiol component was not included.

Curability tests were carried out as in Comparative Example 8, using the Demetron at a sample-to-source distance of 10 mm. This composition scorched within 8 seconds; surface tack of the scorched material was not evaluated.

Three pairs of polycarbonate block shear specimens were assembled (½″×1″ overlap) and cured by irradiating for 40 seconds with two side-by-side Demetrons. The adhesive strengths of the cured assemblies were measured with a 20 kN load cell at a strain rate of 0.5 inch/min. The average adhesive strength obtained was 1036±139 psi. The failure mode was 100% adhesive.

### Example 10

The following composition was prepared on a 10 g scale and mixed in a DAC 400 FVZ speed mixer: 1.23 wt % p-octyloxyphenylphenyliodonium hexafluoroantimonate (initiator), 0.49 wt % camphorquinone (as an initiator), 5.04 wt % TMPTA, 41.68 wt % FX-VEEA, 2.14 it % pentaerythritol tetrakis(3-mercaptopropionate) (“PETMIP”) (thiol component) and 49.42 wt % vinyl ether-capped aliphatic block copolymer with vinyl ether ethoxyacrylate diluent, prepared in Example 3.

Curability tests were carried out as in Comparative Example 9. A dry, rubbery surface is obtained with no scorching after 60 seconds of irradiation. Adhesive strength on polycarbonate was measured as in Comparative Example 9. The average adhesive strength obtained was 1198±79 psi.

### Comparative Example 11

The following comparative composition was prepared on a 10 g scale and mixed in a DAC 400 FVZ speed mixer: 0.48 wt % camphorquinone (as an initiator), 4.80 wt % TMPTA, 33.19 wt % FX-VEEA, 24.29 Wt % partially acrylated bisphenol A epoxy (Ebecryl 3605) and 37.25 wt % hydroxyethyl acrylate capped aromatic block copolymer with vinyl ether ethoxyacrylate diluent, prepared in Example 5. A thiol component was not included.

Curability tests were carried out as in Comparative Example 9. The bulk cure appeared to be complete after 20 seconds of irradiation. After 60 seconds, the top of the sample is fairly tack-free but the sides remain tacky. Moving the Demetron to within 2 mm of the sample and irradiating for 60 seconds fails to provide a completely tack-free surface.

Polycarbonate block shear specimens assembled and cured as in Comparative Example 9 were tested using a 20 kN load cell and a strain rate of 0.05 inch/min. The average adhesive strength obtained was 512±120 psi.

### Example 12

The following composition was prepared on a 10 g scale and mixed in a DAC 400 FVZ speed mixer: 0.47 wt % camphorquinone (initiator), 4.65 wt % TMPTA, 32.42 wt % FX-VEEA, 2.39 wt % pentaerythritol tetrakis(3-mercaptopropionate) (PETMP) (thiol component), 23.65 wt % partially acrylated bisphenol A epoxy (Ebecryl 3605) and 36.41 wt % hydroxyethyl acrylate capped aromatic block copolymer with vinyl ether ethoxyacrylate diluent, prepared in Example 5. This composition was substantially similar to Comparative Example 11, except that it included a thiol component.

Curability tests were carried out as in Comparative Example 9. The bulk cure appeared to be complete after 10 seconds of irradiation; after 60 seconds, the surface is dry and tack-free. Polycarbonate block shear specimens assembled and cured as in Comparative Example 9 were tested using a 20 kN load cell and a strain rate of 0.05 inch/min. The average adhesive strength obtained was 880±66 psi.

### Example 13

A composition was prepared as in Example 12, except that the 0.22 g PETMP was replaced with a different thiol: 0.481 g ethoxylated pentaerythritol (PP150) tetrakis(3-mercaptopropionate) (PP150-TMP) such that the total molar concentration of —SH was held constant. PP150-TMP is an extended derivative of PETMP with a thiol equivalent weight of 266.75 g/mol —SH (commercially available from Robinson Bros. Ltd.). All other ingredients in Example 12 were unaltered.

The resulting composition cured tack-free without scorching within 60 seconds of irradiation with the Demetron.

Polycarbonate block shear specimens were cured by irradiating with the low-intensity LED array (˜15 mW/cm²) for ten minutes; the array provides a more uniform intensity and reduces strain buildup in the curing films. The average adhesion to polycarbonate (tested at 0.05 inch/min as in Examples 4 and 5) was 1107±146 psi.

### Example 14

A composition was prepared as in Example 12, except that the 0.22 g pentaerythritol tetrakis(3-mercaptopropionate) (PETMP) was replaced with a different thiol: 0.217 g tripentaerythritol octakis(thioglycollate) (TPOTG) such that the total molar concentration of —SH was held constant. TPOTG is an octafunctional thiol with equivalent weight 120.5 g/mol —SH. All other ingredients in Example 12 were unaltered.

The resulting composition cured tack-free without scorching within 60 seconds of irradiation with the Demetron.

Polycarbonate block shear specimens were cured with the low-intensity LED array and tested at 0.05 inch/min. The average adhesion to polycarbonate was 1365±117 psi.

### Example 15

A composition was prepared as in Example 12, except that the 0.22 g PETMP was replaced with a different thiol: 0.209 g dipentaerythritol hexakis(thioglycollate) (DPHTG) such that the total molar concentration of —SH was held constant. DPHTG is a hexafunctional thiol with equivalent weight 116 g/mol —SH. All other ingredients in Example 12 were unaltered.

The resulting composition cured tack-free without scorching within 60 seconds of irradiation with the Demetron.

Polycarbonate block shear specimens were cured with the low-intensity LED array and tested at 0.05 inch/ml. The average adhesion to polycarbonate was 1253±227 psi.

### Example 16

Compositions containing the following components were prepared on a 60 g scale using a DAC 400 FVZ speed mixer:

TABLE 10

| Component | Weight % (range) |
|---|---|
| FX-VEEA | 15-50 |
| Acrylate terminated aromatic urethane | 24-70 |
| block copolymer | |
| Ebecryl 3605 | 10-40 |
| PETMP | 0.5-5 |
| 1,3-dimethylbarbituric acid (“DMBA”) | 0.1-1 |
| Camphorquinone | 0.5 |

Block shear specimens (five per composition) were assembled and cured with four passes through a conveyorized visible light source with a peak emission at 470 nm (maximum intensity on part ˜85 mV/cm²; each pass corresponds to approximately 30 seconds of irradiation). Adhesion was measured according to ASTM D4501, referred to above. Test sheets (one per composition) for tensile testing were also cured using 4 passes wider the conveyorized visible light source; each test sheet is 5 inches square and approximately 0.075 inches thick. One test sheet allows for production of up to six dogbones.

To evaluate surface cure, ¼″ holes were drilled in a nylon substrate; these holes were then filled with the compositions (thus ensuring that the sample spot size was consistently ¼″ for all compositions). The spots were irradiated for 40 seconds using an LEDemetron (LED-based dental light, emission max at 470 nm); the sample-to-source distance was set such that the intensity on the sample was 100 mW/cm². The cured surfaces were dusted with silicon carbide grit. Surface tack was then subjectively rated on a scale of 1 to 5 (5 being dry/tack-free) according to how much SiC was retained by the surface after four horizontal and four vertical brushings with a soft brush.

The component quantities and results for two of the compositions (compositions A and B) are provided in Tables 11 and 12 below.

TABLE 11

Weight %
(range)

| Component | A | B |
|---|---|---|
| FX-VEEA | 40-50 | 10-20 |
| Acrylate terminated aromatic | 20-30 | 45-55 |
| urethane block copolymer | | |
| Ebecryl 3605 | 20-30 | 25-35 |
| PETMP | 0.5-1 | 0.5-1 |
| DMBA | 0.5-1 | 0.5-1 |
| Camphorquinone | 0.5 | 0.5 |

TABLE 12

| | Tensile | | | | |
|---|---|---|---|---|---|
| | Strength | Elongation | Adhesion | Surface | Viscosity |
| Composition | (psi) | (%) | (psi) | (5 = best) | (cPs) |
| A | 527 | 70 | 1974 | 5 | 469 |
| B | 1525 | 57 | 1646 | 4 | 39390 |

### Example 17

Compositions containing the following components were prepared on a 60 g scale using a DAC400 FVZ speed mixer:

TABLE 13

| Component | Weight % (range) |
|---|---|
| FX-VEEA | 10-40 |
| Acrylate terminated aromatic urethane | 35-75 |
| block copolymer | |
| N,N-DMAA | 5-25 |
| PETMP | 1 |
| DMBA | 1 |
| Camphorquinone | 0.5 |

The compositions were monitored for surface cure (fresh and after 2 weeks/50° C.), adhesion, tensile strength, elongation and viscosity (fresh and after 2 weeks/50° C.), as described in Example 16 above.

The component quantities and results for two of the compositions (compositions C and D) are provided in Tables 14 and 15 below.

TABLE 14

Weight %
(range)

| Component | C | D |
|---|---|---|
| FX-VEEA | 20-30 | 10-20 |
| Acrylate terminated aromatic | 45-55 | 65-75 |
| urethane block copolymer | | |
| N,N-DMAA | 15-25 | 5-15 |
| PETMP | 1 | 1 |
| DMBA | 1 | 1 |
| Camphorquinone | 0.5 | 0.5 |

TABLE 15

| | Tensile | | | | |
|---|---|---|---|---|---|
| | Strength | Elongation | Adhesion | Surface | Viscosity |
| Composition | (psi) | (%) | (psi) | (5 = best) | (cPs) |
| C | 2229 | 54 | 2495 | 4.3 | 1033 |
| D | 2392 | 86 | 2647 | 5 | 24117 |

### Example 18

A trifunctional block copolymer is prepared in accordance with the following. To a 5 L reaction flask fitted with a mechanical stirrer is added 196.3 g (1 mole; 2 equivalents OH) of HMTD, 348.4 g (2 moles; 4 equivalents NCO) of 2,4-TDI and 700 g of reactive diluent FX-VEEA. The mixture is heated at 70° C. until the isocyanate levels become constant at about half of the original value (˜3 hours). To this mixture is then added 0.5 g stannous 2-ethylhexanoate catalyst followed by 116.2 g (1 mole; 1 equivalent OH) of 4-hydroxybutyl vinyl ether (“HBVE”) and heating is continued until the isocyanate level is reduced to a value corresponding to the complete reaction HBVE (about 1 hour). To this mixture is then added a blend of 163.3 g (0.033 moles; 0.1 equivalents OH) of a propoxylated glycerol triol having a molecular weight of 4900 (hydroxyl number of 34.3) and 900 g (0.45 moles; 0.9 equivalents OH) of poly(tetramethylene oxide) diol having a molecular weight of 2000 (hydroxyl number 56.1) and an additional 0.5 g stannous 2-ethylbexanoate. The mixture is stirred and heated for an additional 3 hours at 70° C., after which all of the isocyanate is consumed. The resultant mixture is a viscous resin composition containing 71% by weight vinyl ether capped urethane block copolymers dissolved in the FX-VEEA monomer. The copolymer component of the composition consists mainly of a blend of an A₃B-type trifunctional block copolymer (˜9% total resin weight) and an A₂B-type difunctional block copolymer (˜62% total resin weight) in which the blocks consist of flexible polyether core segment (B) attached to peripheral rigid urethane end segments capped with vinyl ether groups (A). The resin product is isolated in quantitative yield.

1. A polyurethane block copolymer comprising:
at least one hard segment and at least one soft segment; and
at least two ends, said first end being terminated with a first vinyl ether group and said second end being terminated with a second vinyl ether group.

2. A polyurethane block copolymer comprising the structure: 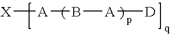
wherein:
A comprises a hard segment;
B comprises a divalent soft segment;
X comprises a q-valent soft segment;
D comprises a vinyl ether group;
p is 0-10; and
q is 2-6.

3. The polyurethane block copolymer according to claim 2, wherein said block copolymer comprises the structure: 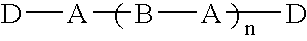
wherein n is 1-10.

4. The polyurethane block copolymer according to claim 2, wherein said hard and soft segments are joined through urethane linkages.

5. The polyurethane block copolymer according to claim 2, wherein A comprises an aromatic, heterocyclic or cycloaliphatic segment derived from a polyisocyanate.

6. The polyurethane block copolymer according to claim 2, wherein A comprises the reaction product of a polyisocyanate and an aromatic, heterocyclic or cycloaliphatic polyol.

7. The polyurethane block copolymer according to claim 6, wherein said polyisocyanate is selected from the group consisting of 2,4-tolylene diisocyanate, isophorone diisocyanate, phenyl diisocyanate, 4,4′-diphenyl diisocyanate, 4,4′-diphenylenemethane diisocyanate, dianisidine diisocyanate, 1,5-naphthalene diisocyanate, 4,41-diphenyl ether diisocyanate, p-phenylene diisocyanate, 4,41-dicyclohexylmethane diisocyanate, 1,3-bis-(isocyanatomethyl)cyclohexane, cyclohexylene diisocyanate, tetrachlorophenylene diisocyanate, 2,6-diethyl-p-phenylenediisocyanate, and 3,5-diethyl-4,4′-diisocyanatodiphenylmethane.

8. The polyurethane block copolymer according to claim 6, wherein said aromatic, heterocyclic or cycloaliphatic polyol is selected from the group consisting of 2,2-(4,4′-dihydroxydiphenyl)-propane, 4,4′-iso-propylidenedicyclohexanol, ethoxylated bisphenol-A, propoxylated bisphenol-A, 2,2-(4,4′-dihydroxydiphenyl))-butane, 3,3-(4,4′-dihydroxydiphenyl)-pentane, α,α′-(4,41-dihydroxydiphenyl))-p-diisopropylbenzene, 1,3-cyclohexane diol, 1,4-cyclohexane diol, 1,4-cyclohexanedimethanol, bicyclic and tricyclic diols, 2,2,4,4-tetramethyl-1,3-cyclobutanediol, hydroquinone, resorcinol, 2,2-(4,4′-dihydroxyphenyl)-sulfone, and 4,4′-oxydiphenol.

9. (canceled)

10. The polyurethane block copolymer according to claim 2, wherein B comprises a multivalent group formed from a component selected from the group consisting of polyether polyols, polyester polyols and hydrogenated hydrocarbon elastomers.

11. The polyurethane block copolymer according to claim 10, wherein said polyether polyol comprises the structure: 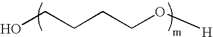
wherein m is 1-70.

12. (canceled)

13. The polyurethane block copolymer according to claim 10, wherein said polyester polyol is selected from the group consisting of poly(caprolactone), poly(1,6-hexanediol adipate), poly(1,6-hexanediol isophthalate), poly(1,4-butanediol adipate) poly(1,4-butanediol isophthalate), poly(diethylene glycol adipate), poly(diethylene glycol adipate isophthalate), poly(ethylene glycol adipate), polyethylene glycol propylene glycol adipate), poly(cyclohexanedimethanol adipate), poly(cyclohexanedimethanol adipate isophthalate), poly(ethylene glycol butylene glycol adipate), poly(1,6-hexanediol neopentyl adipate) and poly(1,6-hexanediol neopentyl isophthalate).

14. The polyurethane block copolymer according to claim 2, wherein said vinyl ether is a derivative of a component selected from the group consisting of 2-hydroxyethyl vinyl ether, 4-hydroxybutyl vinyl ether, cyclohexanedimethanol monovinyl ether, diethylene glycol monovinyl ether, 1,6-hexanediol monovinyl ether and 3-aminopropyl vinyl ether.

15. The polyurethane block copolymer according to claim 2, wherein said block copolymer comprises the structure: 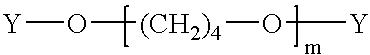
wherein Y is: 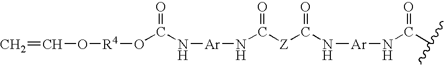
R⁴ is C₁₋₆ alkyl;
Ar is an aryl group derived from a polyisocyanate;
Z is selected from the group consisting of: 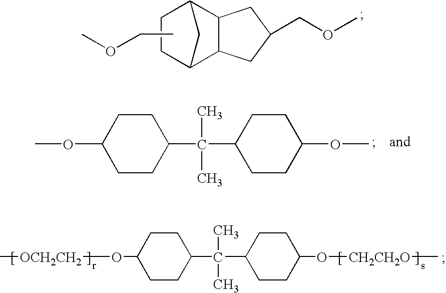
r and s are independently selected from 1-3; and
m is 1-70.

16. A composition comprising:
(a) a polyurethane block copolymer comprising the structure: 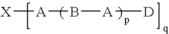
wherein:
A comprises a hard segment;
B comprises a divalent soft segment;
X comprises a q-valent soft segment;
D comprises a vinyl ether group;
p is 0-10; and
q is 2-6;
(b) a reactive diluent comprising at least one vinyl ether or 1-alkenyl ether group and at least one (meth)acrylate group; and
(c) at least one curing initiator.

17. The composition according to claim 16, wherein said reactive diluent comprises the structure: 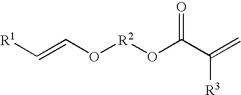
wherein:
R¹ is selected from the group consisting of hydrogen; aliphatic C₁₋₆ alkyl; and C₁₋₆ cycloalkyl;
R² is selected from the group consisting of C₂₋₂₀ alkylene; C₂₋₂₀ hydrocarbon diradical; and polyalkylene oxide; and
R³ is selected from the group consisting of hydrogen and methyl.

18. The composition according to claim 17, wherein said reactive diluent is selected from the group consisting of 2-(2′-vinyloxyethoxy)ethyl acrylate, 2-(2′-vinyloxyethoxyl)ethyl methacrylate, 2-vinyloxyethyl acrylate, 2-vinyloxyethyl methacrylate, 2-(2′-prop-1-enyloxyethoxy)ethyl methacrylate, 2-(2′-prop-1-enyloxyethoxy)ethyl acrylate, and combinations thereof.

19. (canceled)

20. The composition according to claim 16, wherein said at least one curing initiator is selected from the group consisting of UV photoinitiators, visible light photoinitiators, thermal initiators, redox initiators, and combinations thereof.

21. The composition according to claim 20, further comprising a cationic initiator.

22. The composition according to claim 20, wherein said visible light photoinitiator is selected from the group consisting of: camphorquinone; two-component initiators comprising a dye and electron donor; three-component initiators comprising a dye, electron donor and oxidant; and combinations thereof.

23. The composition according to claim 22, wherein said dyes are selected from the group consisting of camphorquinone, 5,7-diiodo-3-butoxy-6-fluorone, rose bengal, riboflavin, eosin Y, benzil, fluorone dyes, benzil derivatives, ketocoumarins, acridine dyes, benzoflavin and combinations thereof.

24. The composition according to claim 22, wherein said electron donors are selected from the group consisting of methyldiethanolamine, dimethyl-p-toluidine, N,N-dimethylaminoethyl methacrylate, ethyl 4-dimethylaminobenzoate, and combinations thereof.

25. The composition according to claim 22, wherein said oxidant is selected from the group consisting of bis(trichloromethyl) triazines, onium salts, and combinations thereof.

26. (canceled)

27. The composition according to claim 16, wherein said block copolymer is present in amounts of about 10% to about 90% by weight of said composition.

28. The composition according to claim 16, further comprising a thiol.

29. The composition according to claim 28, wherein said thiol is selected from the group consisting of pentaerythritol tetrakis(3-mercaptopropionate), ethoxylated pentaerythritol tetrakis(3-mercaptopropionate), pentaerythritol tetrakis(2-mercaptoacetate), tripentaerythritol octakis(thioglycollate), dipentaerythritol hexakis(thioglycollate) and mercapto-propionate and acetate functional oligomers.

30. (canceled)

31. A composition comprising the reaction product of:
(a) a polyurethane block copolymer according to claim 2, further comprising:
(b) a reactive diluent comprising at least one vinyl ether or 1-alkenyl ether group and at least one (meth)acrylate group; and
(c) at least one curing initiator.

32. A composition comprising:
(a) a polyurethane block copolymer comprising the structure: 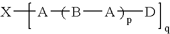
wherein:
A comprises a hard segment;
B comprises a divalent soft segment;
x comprises a q-valent soft segment;
D comprises a (meth)acrylate group;
p is 0-10; and
q is 2-6;
(b) a reactive diluent comprising at least one vinyl ether or 1-alkenyl ether group and at least one (meth)acrylate group; and
(c) at least one curing initiator.

33. A composition comprising the reaction product of claim 32.

34. A process for preparing a composition comprising the steps of:
(a) providing a polyurethane block copolymer comprising the structure: 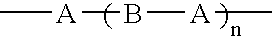
wherein:
A comprises a hard segment;
B comprises a soft segment; and
n is 1-10;
(b) reacting said block copolymer with a vinyl ether compound to form a vinyl ether terminated block copolymer; and
(c) combining said vinyl ether terminated block copolymer with a reactive diluent comprising at least one vinyl ether or 1-alkenyl ether group and at least one (meth)acrylate group.

35. A process for preparing a composition comprising the steps of:
(a) providing a polyurethane block copolymer comprising at least one hard segment and at least one soft segment, said block copolymer terminated with (methacrylate groups; and
(b) combining said (meth)acrylate terminated block copolymer with a reactive diluent comprising at least one vinyl ether or 1-alkenyl ether group and at least one (meth)acrylate group.

36. A method for using the composition of claim 16 to seal together two substrates, comprising the steps of:
(a) applying the composition to at least one of two substrate surfaces;
(b) mating the substrate surfaces in abutting relationship to form an assembly;
(c) exposing the composition to an energy source selected from the group consisting of radiation, heat and combinations thereof; and
(d) maintaining the abutting relationship for a time sufficient to allow the composition to cure.

37. A composition comprising:
(a) a (meth)acrylate;
(b) a reactive diluent comprising at least one vinyl ether or 1-alkenyl ether group and at least one (meth)acrylate group; and
(c) at least one curing initiator.

38. The composition according to claim 37 further comprising a thiol.
